(19) United States
(12) Patent Application Publication
(10) Pub. No.: US 2007/0253677 A1
(43) Pub. Date: Nov. 1, 2007

(54) System for simultaneous playback of multiple video angles from multimedia content onto a display device and method thereof

(76) Inventor: Kang-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/380,210

(22) Filed: Apr. 26, 2006

(51) Int. Cl. H04N 7/00

(52) U.S. Cl. 386/95

(57) ABSTRACT

A method and system for simultaneously displaying multiple video angles of multimedia content onto a single display device includes: reading a video source signal from the multimedia content; demultiplexing the video source signal into a plurality of video angles; decoding at least two of the plurality of video angles according to an encoding scheme of the multimedia content; rendering at least two of the decoded video angles; composing at least two of the rendered video angles into a final video signal; and outputting the final video signal onto the single display device.

### BACKGROUND OF THE INVENTION

1. Field of the Invention

The present invention relates to video playback, more specifically, a system for simultaneous playback of multiple video angles from multimedia content onto a display device and method thereof.

2. Description of the Prior Art

Advancements in multimedia technology have increased the popularity and usage of multimedia contents and videos. Many multimedia video releases provide several enjoyable features, such as subtitles, languages, and multiple camera angles for video scenes. Due to the increasing amount of features provided, the related storage mediums for multimedia contents have also correspondingly increased. For example, a CD disc manages to hold approximately 700 megabytes of data, whereas a DVD disc holds about 4.7 gigabytes. Solid state memory devices are also used for the storage of multimedia contents, with the storage size and physical size varying according to the technology of the relevant device.

For multimedia content that contains multiple video angles, each video angle (corresponding to a specific camera angle) can be selected by a user when viewing content according to his or her viewing preference. A user can also further select amongst the different audio channels, audio configurations, or subtitles during playback for a preferred audio-visual setting during playback.

As described above, each unique camera angle is typically separated into individual video angles within the storage medium (usually being an optical disc). When read by a playback device, a video source signal is extracted which contains the individual video angles multiplexed within the signal. FIG. 1 illustrates a typical video source signal 1 00 from multimedia content. Again, the multimedia content can be contained within any storage medium such as a DVD disc, HDDVD disc, or even a hard disc storage device. The video source signal 100 comprises individual video angles A₁ to Aₙ multiplexed into the single signal line. When viewing the video source signal, a user can then select one of the desired video angles from the available video angles (A₁ to Aₙ) of the video source signal 100 to be shown upon playback.

As an example illustrating this concept, suppose that a football video is produced with simultaneous video angles corresponding to different camera angles to cover the entire football field. A producer may wish to have a video angle to show an aerial (plane) view, another camera for a sideline view, and also a camera from the goal-line. Such a video would therefore have 3 video angles to show simultaneous action of the football game from all the different angles. However, when a viewer decides to view this video, he or she is only capable of choosing one of the three available camera angles at a time for playback.

FIG. 2 illustrates a typical multimedia system 200 used to view multimedia content according to the related art. The multimedia system 200 includes a multimedia disc 210, a multimedia playback device 220, and a display device 230. The multimedia playback device 220 reads a video source signal from the multimedia disc 210. When read by the multimedia playback device 220, the video source signal undergoes three main process steps. The first step is Navigation 222, which involves splitting and selecting one of the video angles from the video source signal. Selection of the video angle is usually determined through a default setting or through a user input of the multimedia playback device 220. The selected video angle is then decoded 224 according to the compression/encoding scheme utilized in the multimedia disc format. Finally, the selected video angle is rendered 226 to provide a proper video output for a corresponding display device 230.

Although multiple video angles are typically available from the video source signal 100, only one related video angle is selected during navigation 222 and then outputted by the multimedia player 220 to the display device 230. Therefore, a viewer of the multimedia content can only view a single video angle a time through a display device 230.

### SUMMARY OF THE INVENTION

According to an exemplary embodiment of the claimed invention, a method for simultaneously displaying multiple video angles of multimedia content onto a single display device is disclosed. The method comprises: reading a video source signal from the multimedia content; demultiplexing the video source signal into a plurality of video angles; decoding at least two video angles of the plurality of video angles according to an encoding scheme of the multimedia content; rendering at least two of the decoded video angles of the plurality of video angles; composing at least two of the rendered video angles into a final video signal; and outputting the final video signal onto the single display device.

According to another exemplary embodiment of the claimed invention, a multimedia playback device is disclosed. The multimedia playback device comprises: a navigation unit for reading a video source signal from multimedia content and demultiplexing the video source signal into a plurality of video angles; at least two decoding units, each decoding unit for decoding a video angle of the plurality of video angles according to an encoding scheme of the multimedia content; at least two rendering units, each rendering unit for simultaneously rendering one of the decoded video angle; and an angle composer for composing the rendered video angles into a final video signal and for outputting the final video signal onto a single display unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a typical video source signal 100 from multimedia content according to the related art.

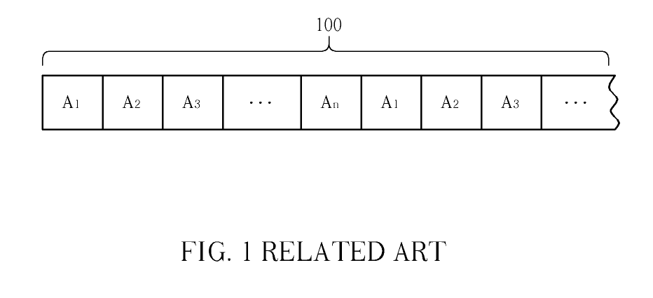

FIG. 2 illustrates a typical multimedia system 200 used to view multimedia content according to the related art.

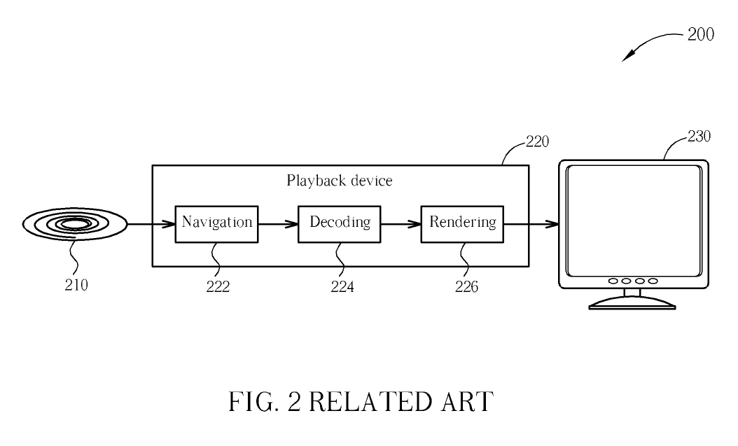

FIG. 3 illustrates a multimedia system 300 for simultaneously displaying multiple video angles from multimedia content onto a single display device according to the present invention.

FIG. 4 is an exemplary embodiment illustrating the possible placement of each selected video angle for the final video output signal for display onto the display device.

FIG. 5 is a process flow chart illustrating the method for simultaneously displaying multiple video angles from multimedia content onto a single display device according to the present invention.

### DETAILED DESCRIPTION

In order to solve the above-mentioned problem, the present invention provides a method for simultaneously viewing multiple video angles of multimedia content onto a single display device. The display device will show the desired video angles onto a single screen according to a user preference or setting. The configuration of the display can also be adjusted according to the user. For example, the video angles can be viewed in a split screen mode or a picture in picture (PiP) mode where the individual video angles can be selected for different areas of the display. As mentioned, each video angle can correspond to a specific camera angle from a certain multimedia content.

Current prior art methods do not allow multiple video angles of the same multimedia content to be displayed simultaneously onto a single display device. Using prior art methods, a viewer is generally limited to only watching one specific camera angle at a time onto a single display device. However, if watching a football video similar to that described above, a user may want to simultaneously view the game from several angles. This would allow him or her to fully enjoy the simultaneous action of the game, and perhaps see entire plays that could not otherwise be seen from just a single angle or view. Watching multiple video angles simultaneously can therefore help improve efficiency and reduce viewing times while enhancing viewing pleasure. It may also help reduce the need to replay specific scenes at different angles as they would just be simultaneously displayed at once. Furthermore, this method provides a producer of multimedia content increased flexibility in filmmaking, as titles can be specially produced with this feature in mind.

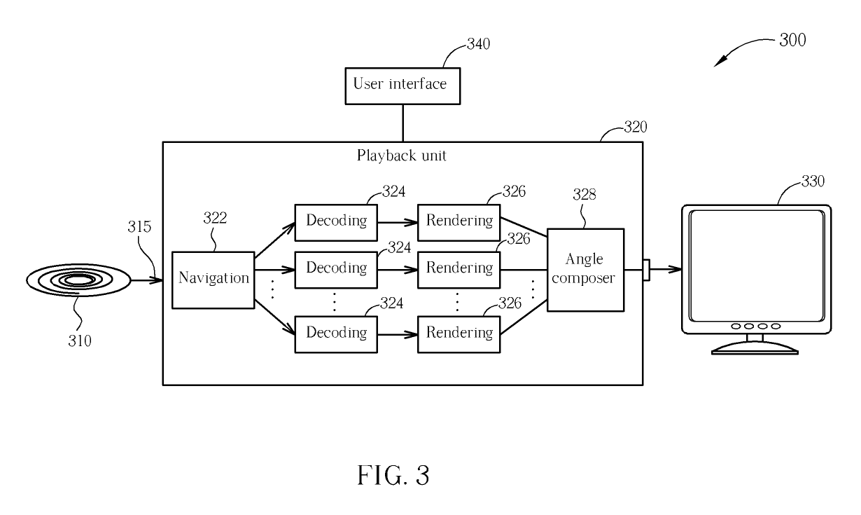

FIG. 3 is an embodiment illustrating a multimedia system 300 for simultaneously displaying multiple video angles from multimedia content onto a single display device, according to an exemplary embodiment of the present invention. The multimedia system 300 includes multimedia content 310, a multimedia playback unit 320, and a display device 330 coupled to the multimedia playback unit 320.

The multimedia content 310 can be an optical disc (DVD, VCD, BD, HDDVD), a hard disc format storage unit or solid state memory. The multimedia content 310 further comprises multimedia data including a plurality of video angles. The video angles can correspond to different camera angles of specific video footage, or to different camera shots altogether as arbitrarily created by the producer of the multimedia content 310. The multimedia data forms the video source signal 315, which is read by the multimedia playback unit 320. The video source signal 315 can also represent a satellite TV signal, a digital TV signal or a high-definition digital TV (HDTV) signal, while the multimedia content 310 would then represent the program sent from the TV service provider.

Upon reading the video source signal 315 of the multimedia content 310, the multimedia playback unit 320 undergoes a series of process steps before providing multiple track outputs onto the display device 330. The first step is conducted in Navigation 322, where the video source signal 315 is demultiplexed (or split) into different separate video angles. Again, each video angle generally corresponds to a specific camera angle or view of a screen shot, but can also correspond to any type of video footage as produced by the creator of the multimedia content 310. Upon demultiplexing the video source signal 315, each individual video angle is individually decoded 324. FIG. 3 illustrates a plurality of decoding blocks 324 signifying the decoding of each separate video angle according to the available number of video angles. Upon decoding each video angle, they are subjected to rendering 326 to prepare each video angle for output to a display device 330. FIG. 3 again illustrates a plurality of rendering blocks 326 signifying the rendering process performed on each separate video angle according to the available number of video angles. Once rendering is completed, each video angle is routed into an angle composer 328. The angle composer 328 receives each separate rendered video angle, and composes the video angles into the final format video signal. The final video signal is then outputted it onto a single display unit 330.

The description above introduces an embodiment of the present invention that simultaneously outputs all the video angles included in the multimedia content onto the single display 330. However, the multimedia system 300 may further include a user interface 340 coupled to the playback unit 320 as illustrated in FIG. 3 for allowing a viewer of the multimedia content to select the video angles for output to the display unit 330. The multimedia system 300 may still demultiplex all video angles, but decode only the selected ones. In this way, the decoding units 324 and rendering units 326 only process the desired video angles as already selected by the user. In fact, the point or stage of selection for the desired video angles is intermediate, and can occur anytime during the video process providing that the desired result of the present invention is obtained. For example, in another embodiment all demultiplexed video angles may be all decoded but only the selected ones are sent for rendering 326. In yet another embodiment, the present invention can comprise rendering all video angles comprised in the multimedia content but only send the selected ones to the angle composer 328. The angle composer 328 composes the final video signal with only the desired video angles.

Another embodiment (not shown) can utilize different format decoding units and rendering units. The navigation unit in this embodiment reads a video source signal from the multimedia content and demultiplexes it into a plurality of video angles. A single decoding unit is used and simultaneously decodes each video angle of the multimedia content according to the encoding scheme. Also, a rendering simultaneously renders each video angle of the plurality of video angles. When rendered, an angle composer composes the video angles into a final video signal and outputs it onto a single display unit.

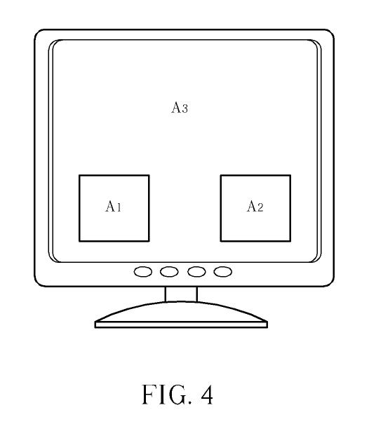

As previously described, the final video signal may be implemented in a split screen mode, a picture in picture (PiP) mode, or any viewing mode as desired by a user. The angle composer 328 will also select the placement of each selected video angle onto the final video output signal. An example of this is shown in FIG. 4. In this embodiment, a PiP mode is used where the angle composer has selected angle A1 to be displayed on the lower left corner, angle A2 can be displayed the lower right corner, and angle A3 to consume the remaining display area. Another embodiment (not shown) may have a split screen mode, where video signals can be arbitrarily divided among the total screen area. The final video output signal is then sent from the multimedia playback unit 320 to a single display unit 330.

The multimedia playback unit 320 can be a DVD player, an optical disc player, a computer, or a graphics device card. Regardless of the specific apparatus type of the multimedia playback unit 320, it performs the necessary processing as indicated in FIG. 3. The display device 330 can be a television, a projector, an LCD display, or a computer monitor.

A user interface 340 can also be further coupled to the multimedia playback unit 320 for a viewer to input desired playback settings. For example, a user can specify the specific video angles to be sent to the video display 330 through the user interface 340. The user can also specify the configuration of the video angles, the type of display (PiP or split screen) and the location of each video angle in the final format video signal for display. The user interface 340 therefore comprises the proper input and output terminals to communicate relevant viewing options to the user. A user selection of the desired video angles can occur through the navigation unit 322 such that only the desired angles are demultiplexed, or through the angle composer 328 such that all angles are processed, but only the desired angles are composed into the final video signal.

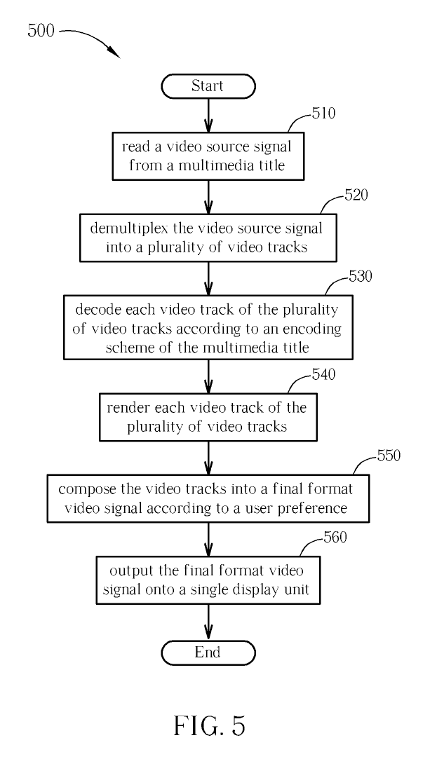

A method for simultaneous display of multiple video angles from multimedia content onto a single display device according to an exemplary embodiment of the present invention is further detailed through the process steps shown in FIG. 5. Provided that substantially the same result is achieved, the steps of the process 500 need not be in the exact order shown and need not be contiguous, that is, other steps can be intermediate. In this embodiment, the method for simultaneous display of multiple video angles from multimedia content onto a single display device is as follows:

Step 510: read a video source signal from a multimedia content

Step 520: demultiplex the video source signal into a plurality of video angles

Step 530: decode each video angle of the plurality of video angles according to an encoding scheme of the multimedia content

Step 540: render each video angle of the plurality of video angles

Step 550: compose the video angles into a final format video signal according to a user preference

Step 560: output the final format video signal onto a single display unit

The present invention therefore provides a method and device to solve the need for simultaneously displaying multiple angles of multimedia content onto a single display device. This allows a viewer of a multimedia content to have an option of viewing multiple, or even all of the included video angles of a multimedia content at the same time to enhance overall viewing pleasure. Furthermore, a user can select the desired video angles to be viewed according to the available video angles in the multimedia content.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simultaneously displaying multiple video angles of multimedia content onto a single display device, the method comprising:
reading a video source signal from the multimedia content;
demultiplexing the video source signal into a plurality of video angles;
decoding at least two of the demultiplexed video angles according to an encoding scheme of the multimedia content;
rendering at least two of the decoded video angles;
composing at least two of the rendered video angles into a final video signal; and
outputting the final video signal onto the single display device.

2. The method of claim 1, wherein the multimedia content comprises a digital versatile disc (DVD), a high-definition DVD (HDDVD), or a blue-ray disc (BD).

3. The method of claim 1, wherein the multimedia content comprises an optical disc.

4. The method of claim 1, wherein the multimedia content comprises a solid state memory device.

5. The method of claim 1, wherein the video source signal comprises a digital TV (DTV) satellite signal or a high-definition digital TV (HDTV) signal.

6. The method of claim 1 further comprising
selecting at least two desired video angles.

7. The method of claim 6 further comprising decoding the selected video angles according to an encoding scheme of the multimedia content.

8. The method of claim 6 further comprising rendering the selected video angles.

9. The method of claim 6 further comprising composing the selected video angles.

10. The method of claim 1, wherein the step of outputting the final video signal onto the single display device comprises displaying the final video signal onto the single display device in a split screen mode.

11. The method of claim 1, wherein the step of outputting the final video signal onto the single display device comprises displaying the final video signal onto the single display device in a picture in picture (PiP) mode.

12. A multimedia playback system comprising:
a navigation unit for reading a video source signal from multimedia content and demultiplexing the video source signal into a plurality of video angles;
at least two decoding units, each of the decoding units for simultaneously decoding one video angle of the plurality of video angles according to an encoding scheme of the multimedia content;
at least two rendering units, each of the rendering unit for simultaneously rendering one of the decoded video angles; and
an angle composer for composing at least two of the rendered video angles into a final video signal and for outputting the final video signal onto a single display unit.

13. The multimedia playback system of claim 12, wherein the multimedia content comprises a digital versatile disc (DVD), an high-definition DVD (HDDVD), or a blue-ray disc (BD).

14. The multimedia playback system of claim 12 wherein the multimedia content comprises an optical disc.

15. The multimedia playback system of claim 12, wherein the multimedia content comprises a solid state memory device.

16. The multimedia playback system of claim 12, wherein the video source signal comprises a digital TV (DTV) satellite signal or a high-definition digital TV (HDTV) signal.

17. The multimedia playback system of claim 12 further comprising a user interface for allowing a viewer of the multimedia content to select at least two video angles of the plurality of video angles for display.

18. The multimedia playback system of claim 17, wherein the decoding units are for simultaneously decoding the selected video angles.

19. The multimedia playback system of claim 17, wherein the rendering units are for simultaneously rendering the selected video angles.

20. The multimedia playback system of claim 17, wherein the angle composer is for composing the selected video angles.
